(19) United States
(12) Patent Application Publication
(10) Pub. No.: US 2024/0238996 A1
(43) Pub. Date: Jul. 18, 2024

(54) FOLDING KNIFE WITH SPRING-ANCHORED PIVOT

(71) Applicant: Spyderco, Inc., Golden, CO (US)

(72) Inventor: Michael Read, Flore (GB)

(21) Appl. No.: 18/155,040

(22) Filed: Jan. 16, 2023

(51) Int. Cl. B26B 1/04

(52) U.S. Cl. CPC B26B 1/044

(57) ABSTRACT

A folding knife is provided with a deflectable pivot that provides a varying bias force as the blade is rotated between the closed and open positions. Specifically, the pivot secures the blade to bias members of a handle, and the bias members deform relative to other parts of the handle to allow the pivot to move and to provide the varying bias force. A cam surface on the tang of the blade operatively engages a pin of the handle to control the deflection of the pivot and the bias members. The cam surface and the resulting bias force are arranged to locate and keep the blade in the open or closed positions like a detent mechanism to reduce the likelihood of an unintentional opening or closing of the blade and to improve the safety of the folding knife.

### FIELD OF THE INVENTION

The present disclosure relates to tools and cutting instruments and more specifically to folding tools with a blade connected to a handle with components that urge and locate the blade into the closed position or the open position like a detent mechanism.

### BACKGROUND OF THE INVENTION

Cutting instruments have been used for centuries by craftsmen, hunters, and others requiring a sharp cutting instrument. Pocket knives are commonly carried by sportsmen, craftsmen and other users who desire a compact, portable blade which can be safely folded and transported in a pocket or attached to a belt. More recently, fixed length knives have been replaced with popular folding knives, which generally have two positions. In an open or extended position of use, the knife cutting blade is extended to expose the blade cutting edge and permit cutting therein. In a closed position, the cutting edge of the blade is stored within a cavity or recess in the handle of the knife, thus preventing the blade from being exposed.

There is a potential safety issue if the blade is not reliably held in the open position or the closed position. For instance, if the blade is not reliably held in the closed position, a user may assume that the cutting edge of the blade is safely stored within the cavity or recess of the handle when the cutting edge is actually exposed and could potentially harm the user. Conversely, if the blade is not reliably held in the open position, a user may assume that the cutting edge of the blade is in the fully extended position when the blade is actually partially closed, which may cause the user to misapply the knife to an object, prematurely close the blade, etc.

Some folding knives incorporate one or more mechanisms to more reliably hold the blade in a particular position. For example, some folding knives have a locking mechanism that locks the blade in the open or extended position. The locking mechanism may automatically lock the blade in the open position once the user rotates the blade to the open position, or the user may need to perform an additional action to engage the locking mechanism. Then, the user can use the folding knife with the blade reliably in the open position. Once the user desires to rotate the blade to the closed position, the user may need to perform yet another action to disengage the locking mechanism and allow the blade to rotate out of the open position.

Other mechanisms also modify and control the operation of the blade relative to the handle. For example, a locking mechanism may be utilized to hold the blade in the closed position to prevent the unintended exposure of the cutting edge of the blade. A user may need to perform a further action to disengage the locking mechanism and allow the blade to rotate out of the closed position. Further still, a folding knife may incorporate an opening mechanism that assists a user when the user moves the blade from the closed position to the open position. Some folding knives have a handle that comprises a first scale and a second scale, and the recess of the handle is generally disposed between the scales. The blade rotates between positions about a pivot, which also spans and joins the scales. A user may find it difficult to apply a sufficient movement force to the blade to rotate the blade out of the closed position, for instance, if there is a large friction force between the blade and the scales, or if the scales largely conceal the blade and there is only a small portion of the blade available for the user to grasp. An opening mechanism can assist a user with part of the operation to move the blade even when a user is able to apply only a relatively small movement force to the blade.

Various disclosures describe different types of mechanisms for folding knives. U.S. Pat. No. 6,553,672 to Glesser et al. discloses a folding knife with a compression locking mechanism, and is incorporated by reference herein in its entirety. U.S. Pat. No. 6,918,184 to Glesser discloses a folding knife lock integral stop pin, and is incorporated by reference herein in its entirety. U.S. Pat. No. 6,751,868 to Glesser discloses a folding knife with a substantially spherical locking mechanism, and is incorporated by reference herein in its entirety. U.S. Pat. No. 9,327,413 to Sakai discloses a folding knife with a two-piece backlock, and is incorporated by reference herein in its entirety. U.S. Patent Publication No. 2016/0136824 to Glesser discloses a folding knife with a rotational wedge locking mechanism, and is incorporated by reference herein in its entirety. U.S. Pat. No. 5,615,484 to Pittman discloses a cam lock for a folding knife blade, and is incorporated by reference herein in its entirety. U.S. Pat. No. 4,985,998 to Howard discloses a folding knife with a blade lock, and is incorporated by reference herein in its entirety. U.S. Pat. No. 5,596,808 to Lake et al. discloses a folding knife with a liner lock, and is incorporated by reference herein in its entirety.

While locking, opening, and/or other mechanisms assist a user with different parts of operating the folding knife, these mechanisms can increase the complexity of the folding knife. Thus, these mechanisms are a potential point of failure, which can render the folding knife potentially unsafe for use or storage. The increased complexity also increases the production costs for the folding knife, and these mechanisms add weight to the folding knife, which can diminish the portable nature of the folding knife.

Thus, there is a strong need in the cutlery industry for a folding knife that assists a user in operating the folding knife while avoiding an increase in the complexity or the weight of the folding knife.

### SUMMARY OF THE INVENTION

A folding knife is provided herein that assists a user by urging and locating a blade in a closed position or an open position without an increase in the complexity or the weight of the folding knife. The blade is connected to a handle via a movable pivot, and the pivot is connected to a bias member of the handle. As a user rotates the blade, a cam surface on a tang of the blade rotates against a pin of the handle. The shape of the cam surface moves the pivot relative to the pin, which changes a deformation of the bias member and a resulting bias force generated by the bias member. This bias force, along with other components described herein, urges and locates the blade into the closed position or the open position like a detent mechanism. This reduces the likelihood of an unintentional opening or closing of the blade to improve the safety of the folding knife.

One aspect of embodiments of the present disclosure is to provide a folding knife with bias members. In some embodiments, a bias member is a part of the handle itself, e.g., part of a scale. One end of the bias member is connected to a body portion of the scale, and an aperture is positioned at an opposing end of the bias member. With two scales that form the handle, a pivot joins the apertures of the deforming bias members, and a pin joins the non-deforming body portions. As the pivot moves positions relative to the pin, the bias members physically deform within an elastic range of deformation, which causes the bias members to impart a bias force on the pivot. This bias force is translated to the cam surface and then the pin. The direction of the bias force is such that the farther the pivot moves the from the pin, the stronger the bias force urges the pivot and the cam surface toward the pin. As described herein, the bias force operates with other aspects, features, and components of the folding knife to urge and locate the blade into an open position or a closed position.

It is another aspect of embodiments of the present disclosure to provide a folding knife with a cam surface on the tang of the blade that contacts the pin and varies the position of the pivot as the blade rotates relative to the handle. The cam surface has a varying shape as measured from the axis of rotation of the pivot, and the cam surface can have depressions, protrusions, and other shapes. For instance, when the rotational position of the blade is such that a depression of the cam surface contacts the pin, then the pivot is closer to the pin, and the bias members are less deformed and generate a small bias force. When the rotational position of the blade is such that a protrusion of the cam surface contacts the pin, the pivot is pushed away from the pin, and the bias members experience a larger deformation, which generates a larger bias force. These shapes can be arranged to urge and locate the blade in the closed position or the open position.

In one example, a depression corresponds to the closed position of the blade, and a protrusion is located adjacent to the depression in the opening direction. Thus, as a user starts to apply a movement force to the blade to rotate the blade out of the closed position, the protrusion starts to engage the pin, the bias members deform more, and the bias force increases. If the apex of the protrusion does not clear the pin and the user releases the movement force, then the increased bias force causes the blade to snap back into the closed position such that the depression contacts the pin, like a detent mechanism. Accordingly, the blade is urged and located in the closed position to reduce the likelihood of an unintentional opening of the blade. Instead, a user must apply a sufficient movement force on the blade to push the protrusion past the pin and continue the opening motion of the blade.

A depression and a protrusion can operate in a similar manner for the open position where the depression corresponds to the open position of the blade. If the apex of the protrusion does not clear the pin and the user releases the movement force, then the increased bias force causes the blade to snap back into the open position such that the depression contacts the pin, like a detent mechanism. A user must apply a sufficient movement force on the blade to push the protrusion past the pin and continue the closing motion of the blade. The open depression and the open protrusion may be arranged such that one movement force is required to push the open protrusion past the pin, and the closed depression and the closed protrusion may be arranged such that another movement force is required to push the closed protrusion past the pin. These movement forces may be the same or distinct, depending on the arrangement of the protrusions and depressions of the cam surface on the tang of the blade.

In some embodiments, a protrusion of the cam surface can also operate like a spring-assisted opening or closing mechanism. In the instance of a closed protrusion when the apex of the closed protrusion contacts the pin, the large bias force in combination with a small movement force in the opening direction can propel the blade in the opening direction. Similarly, in the instance of an open protrusion when the apex of the open protrusion contacts the pin, the large bias force in combination with a small movement force in the closing direction can propel the blade in the closing direction.

One particular embodiment of the present disclosure is a folding knife, comprising a handle having a first scale and a second scale joined at a pivot and at a pin; a blade having a tip and a tang opposite the tip, a portion of the blade positioned between the first and second scales, wherein the pivot extends through a pivot aperture in the tang of the blade, and the blade is configured to rotate about the pivot and relative to the handle between a closed position and an open position; and the tang of the blade having a cam surface with a depression and a protrusion, wherein the depression is configured to contact the pin so that the pivot is a first distance from the pin, and the protrusion is configured to contact the pin so that the pivot is a second distance from the pin, and wherein the second distance is greater than the first distance.

In some embodiments, the depression is configured to contact the pin to locate the blade in one of the closed position or the open position. In various embodiments, the protrusion is configured to contact the pin as the blade is between the closed position and the open position. In some embodiments, the folding knife further comprises a first bias member of the first scale; and a second bias member of the second scale, wherein the pivot extends through a first aperture in the first bias member and through a second aperture in the second bias member, and the first and second bias members are configured to selectively deform as the pivot moves relative to the pin, and deformation of the first and second bias members generates a bias force on the pivot, the cam surface, and the pin.

In various embodiments, one end of the first bias member is connected to a first body portion of the first scale, and the first aperture is positioned at an opposing end of the first bias member, and wherein one end of the second bias member is connected to a second body portion of the second scale, and the second aperture is positioned at an opposing end of the second bias member. In some embodiments, the blade is configured to receive a movement force to rotate the cam surface against the pin, and the movement force is a function of at least the bias force and a position of the cam surface relative to the pin. In various embodiments, a fastener joins an aft end of the first scale to an aft end of the second scale.

Another particular embodiment of the present disclosure is a folding knife, comprising a handle having a first scale with a first body portion and a first bias member, and the handle having a second scale with a second body portion and a second bias member, wherein the first and second bias members are joined with a pivot, and the first and second body portions are joined with a pin; a blade positioned between the first and second scales, wherein the pivot extends through a pivot aperture in the blade, and the blade is configured to rotate about the pivot and relative to the handle; wherein, in a first rotation position of the blade relative to the handle, the first and second bias members are configured to deform relative to the respective first and second body portions such that the first and second bias members apply a first bias force on the pivot and the pin; and wherein, in a second rotation position of the blade relative to the handle, the first and second bias members are configured to deform relative to the respective first and second body portions such the first and second bias members apply a second bias force on the pivot and the pin that is greater than the first bias force.

In some embodiments, in the first rotation position of the blade relative to the handle, the pivot is a first distance from the pin; and wherein, in the second rotation position of the blade relative to the handle, the pivot is a second distance from the pin that is greater than the first distance. In various embodiments, the second distance is a maximum distance between the pivot and the pin, and deformation of the first and second bias members at the second distance is configured to remain in an elastic range below an elastic limit. In some embodiments, the first body portion and the first bias member of the first scale are a single continuous structure, and the second body portion and the second bias member of the second scale are a single continuous structure.

In various embodiments, the first bias member is connected to the first body portion at only a base of the first bias member, and the second bias member is connected to the second body portion at only a base of the second bias member. In some embodiments, the pivot extends through a first aperture in the first bias member, and a length between a center of the first aperture and the base is greater than a width of the base. In various embodiments, the first body portion circumscribes the first bias member, and the second body portion circumscribes the second bias member, and wherein the first and second bias members are joined with the pivot, and the first and second body portions are joined with the pin. In some embodiments, the first bias member circumscribes the first body portion, and the second bias member circumscribes the second body portion, and wherein the first and second bias members are joined with the pin, and the first and second body portions are joined with the pivot.

A further particular embodiment of the present disclosure is a folding knife, comprising a handle having a first scale and a second scale joined at a pivot and at a pin; a blade positioned between the first and second scales, wherein the pivot extends through a pivot aperture in the blade, and the blade is configured to rotate about the pivot and relative to the handle between a closed position and an open position; a tang of the blade having a cam surface with an intermediate portion defined by a constant radius, wherein the cam surface has a closed protrusion at one end of the intermediate portion and an open protrusion at an opposing end of the intermediate portion; wherein the blade is configured to receive a first movement force to move the closed protrusion past the pin, deflect the pivot relative to the pin, and locate the blade in the closed position; and wherein the blade is configured to receive a second movement force to move the open protrusion past the pin, deflect the pivot relative to the pin, and locate the blade in the open position.

In some embodiments, the cam surface comprises a closed depression adjacent to one end of the intermediate portion and an open depression adjacent to the opposing end of the intermediate portion, and wherein the closed depression is configured to contact the pin to locate the blade in the closed position, and the open depression is configured to contact the pin to locate the blade in the open position. In various embodiments, a rotation axis of the pivot is offset from a center a circle defined by the radius, and wherein the closed protrusion is the part of the intermediate portion that is adjacent to the closed depression, and the open protrusion is the part of the intermediate portion that is adjacent to the open depression.

In some embodiments, the closed protrusion and the open protrusion each extend outward beyond a circle defined by the radius, wherein the closed protrusion is positioned between a closed depression and the intermediate portion, and the open protrusion is positioned between an open depression and the intermediate portion, wherein the closed depression is configured to contact the pin to locate the blade in the closed position, and the open depression is configured to contact the pin to locate the blade in the open position, and wherein a rotation axis of the pivot is aligned with a center of the circle defined by the radius. In various embodiments, the folding knife further comprises a first bias member of the first scale; and a second bias member of the second scale, wherein the pivot extends through a first aperture in the first bias member and through a second aperture in the second bias member, and the first and second bias members are configured to deform and generate a bias force on the pivot, the cam surface, and the pin as the cam surface rotates against the pin. In some embodiments, the bias force is configured to urge the blade into the closed position as the closed protrusion moves past the pin, and the bias force is configured to urge the blade into the open position as the open protrusion moves past the pin.

One particular embodiment of the present disclosure is a folding knife, comprising a handle having a first scale and a second scale joined at a pivot and at a pad, wherein the first scale, the second scale, and the pad are a single continuous structure; a blade positioned between the first and second scales, wherein the pivot extends through a pivot aperture in the blade, and the blade is configured to rotate about the pivot and relative to the handle between a closed position and an open position; and a tang of the blade having a cam surface with a depression and a protrusion, wherein the depression is configured to contact the pad so that the pivot is a first distance from the pad, and the protrusion is configured to contact the pin so that the pivot is a second distance from the pad, and wherein the second distance is greater than the first distance.

In some embodiments, the depression is configured to contact the pad to locate the blade in one of the closed position or the open position. In various embodiments, the protrusion is configured to contact the pad as the blade is between the closed position and the open position. In some embodiments, the folding knife further comprises a first bias member of the first scale; and a second bias member of the second scale, wherein the pivot extends through a first aperture in the first bias member and through a second aperture in the second bias member, and the first and second bias members are configured to selectively deform as the pivot moves relative to the pad, and deformation of the first and second bias members generates a bias force on the pivot, the cam surface, and the pad.

In various embodiments, one end of the first bias member is connected to a first body portion of the first scale, and the first aperture is positioned at an opposing end of the first bias member, and wherein one end of the second bias member is connected to a second body portion of the second scale, and the second aperture is positioned at an opposing end of the second bias member. In various embodiments, the blade is configured to receive a movement force to rotate the cam surface against the pad, and the movement force is a function of at least the bias force and a position of the cam surface relative to the pad.

Another particular embodiment of the present disclosure is a folding knife, comprising a handle having a first scale with a first body portion and a first bias member, and the handle having a second scale with a second body portion and a second bias member, wherein the first and second bias members are joined with a pivot, and the first and second body portions are joined with a pad, wherein the first scale, the second scale, and the pad are a single continuous structure; a blade positioned between the first and second scales, wherein the pivot extends through a pivot aperture in the blade, and the blade is configured to rotate about the pivot and relative to the handle; wherein, in a first rotation position of the blade relative to the handle, the first and second bias members are configured to deform relative to the respective first and second body portions such that the first and second bias members apply a first bias force on the pivot and the pad; and wherein, in a second rotation position of the blade relative to the handle, the first and second bias members are configured to deform relative to the respective first and second body portions such the first and second bias members apply a second bias force on the pivot and the pad that is greater than the first bias force.

In various embodiments, in the first rotation position of the blade relative to the handle, the pivot is a first distance from the pad; and wherein, in the second rotation position of the blade relative to the handle, the pivot is a second distance from the pad that is greater than the first distance. In some embodiments, the second distance is a maximum distance between the pivot and the pad, and deformation of the first and second bias members at the second distance is configured to remain in an elastic range below an elastic limit.

In various embodiments, the first bias member is connected to the first body portion at only a base of the first bias member, the pivot extends through a first aperture in the first bias member, and a length between a center of the first aperture and the base is greater than a width of the base. In some embodiments, the first body portion circumscribes the first bias member, and the second body portion circumscribes the second bias member. In some embodiments, the first bias member circumscribes the first body portion, and the second bias member circumscribes the second body portion.

A further particular embodiment of the present disclosure is a folding knife, comprising a handle having a first scale and a pad, wherein the first scale and the pad are a single continuous structure; a blade having a tip and a tang opposite the tip, a portion of the blade positioned adjacent to the first scale, wherein a pivot extends through a pivot aperture in the tang of the blade and into the first scale, and the blade is configured to rotate about the pivot and relative to the handle between a closed position and an open position; the tang of the blade having a cam surface with an intermediate portion defined by a constant radius, wherein the cam surface has a closed protrusion at one end of the intermediate portion and an open protrusion at an opposing end of the intermediate portion; wherein the blade is configured to receive a first movement force to move the closed protrusion past the pad, deflect the pivot relative to the pad, and locate the blade in the closed position; and wherein the blade is configured to receive a second movement force to move the open protrusion past the pad, deflect the pivot relative to the pad, and locate the blade in the open position.

In some embodiments, the cam surface comprises a closed depression adjacent to one end of the intermediate portion and an open depression adjacent to the opposing end of the intermediate portion, and wherein the closed depression is configured to contact the pad to locate the blade in the closed position, and the open depression is configured to contact the pad to locate the blade in the open position. In various embodiments, a rotation axis of the pivot is offset from a center a circle defined by the constant radius, and wherein the closed protrusion is the part of the intermediate portion that is adjacent to the closed depression, and the open protrusion is the part of the intermediate portion that is adjacent to the open depression. Thus, in various embodiments, the closed protrusion is directly adjacent to the closed depression, and the open protrusion is directly adjacent to the open depression. In some embodiments, the closed protrusion and the open protrusion each extend outward beyond a circle defined by the constant radius, wherein the closed protrusion is positioned between a closed depression and the intermediate portion, and the open protrusion is positioned between an open depression and the intermediate portion, wherein the closed depression is configured to contact the pad to locate the blade in the closed position, and the open depression is configured to contact the pad to locate the blade in the open position, and wherein a rotation axis of the pivot is aligned with a center of the circle defined by the radius.

In various embodiments, the handle comprises only the first scale and the pad. In some embodiments, the folding knife further comprises a second scale, wherein the first scale and the second scale are joined at the pivot and at the pad, wherein the first scale, the second scale, and the pad are a single continuous structure, and the blade is positioned between the first and second scales; a first bias member of the first scale; and a second bias member of the second scale, wherein the pivot extends through a first aperture in the first bias member and through a second aperture in the second bias member, and the first and second bias members are configured to deform and generate a bias force on the pivot, the cam surface, and the pad as the cam surface rotates against the pad. In some embodiments, the bias force is configured to urge the blade into the closed position as the closed protrusion moves past the pad, and the bias force is configured to urge the blade into the open position as the open protrusion moves past the pad.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification, drawings, and claims are to be understood as being modified in all instances by the term “about.” Furthermore, ranges have been discussed and used within the description. One skilled in the art would understand that any sub-range within the stated range would be suitable, as would any number within the broad range, without deviating from the invention.

The term “a” or “an” entity, as used herein, refers to one or more of that entity. As such, the terms “a” (or “an”), “one or more,” and “at least one” can be used interchangeably herein.

The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. Section 112(f). Accordingly, a claim incorporating the term “means” shall cover all structures, materials, or acts set forth herein, and all equivalents thereof. Further, the structures, materials, or acts, and the equivalents thereof, shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and Detailed Description and no limitation as to the scope of the present invention is intended by either the inclusion or non-inclusion of elements, components, etc. in this Summary of the Invention. Additional aspects of the present invention will become more readily apparent from the Detailed Description particularly when taken together with the drawings. Additional images of a folding knife and related components are shown in the Appendix, which is incorporated herein in its entirety by reference.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1A is a front elevation view of a folding knife in an open and extended position in accordance with an embodiment of the present disclosure;

FIG. 1B is a rear elevation view of the folding knife in FIG. 1A in accordance with an embodiment of the present disclosure;

FIG. 1C is a top plan view of the folding knife in FIG. 1A in accordance with an embodiment of the present disclosure;

FIG. 2 is a front elevation view of a blade of the folding knife in FIG. 1A in accordance with an embodiment of the present disclosure;

FIG. 3 is a front elevation view of a first scale of the folding knife in FIG. 1A in accordance with an embodiment of the present disclosure

FIG. 4A is a front elevation view of the folding knife in FIG. 1A in a closed position in accordance with an embodiment of the present disclosure;

FIG. 4B is a front elevation view of a pin and a cam surface of the folding knife in FIG. 4A in accordance with an embodiment of the present disclosure;

FIG. 5A is a front elevation view of the folding knife in FIG. 1A in a position between the closed and open positions in accordance with an embodiment of the present disclosure;

FIG. 5B is a front elevation view of a pin and a cam surface of the folding knife in FIG. 5A in accordance with an embodiment of the present disclosure;

FIG. 6A is a front elevation view of the folding knife in FIG. 1A in a further position between the closed and open positions in accordance with an embodiment of the present disclosure;

FIG. 6B is a front elevation view of a pin and a cam surface of the folding knife in FIG. 6A in accordance with an embodiment of the present disclosure;

FIG. 7A is a front elevation view of the folding knife in FIG. 1A in yet a further position between the closed and open positions in accordance with an embodiment of the present disclosure;

FIG. 7B is a front elevation view of a pin and a cam surface of the folding knife in FIG. 7A in accordance with an embodiment of the present disclosure;

FIG. 8A is a front elevation view of the folding knife in FIG. 1A in an open position in accordance with an embodiment of the present disclosure;

FIG. 8B is a front elevation view of a pin and a cam surface of the folding knife in FIG. 8A in accordance with an embodiment of the present disclosure;

FIG. 9A is a front elevation view of a pin and a cam surface of a folding knife in accordance with an embodiment of the present disclosure;

FIG. 9B is a front elevation view of a pin and another cam surface of a folding knife in accordance with an embodiment of the present disclosure;

FIG. 9C is a front elevation view of a pin and a further cam surface of a folding knife in accordance with an embodiment of the present disclosure;

FIG. 10A is a front elevation view of a folding knife in an open and extended position in accordance with an embodiment of the present disclosure;

FIG. 10B is a rear elevation view of the folding knife in FIG. 10A in accordance with an embodiment of the present disclosure; and

FIG. 10C is a top plan view of the folding knife in FIG. 10A in accordance with an embodiment of the present disclosure.

To provide further clarity to the detailed description provided herein in the associated drawings, the following list of components and associated numbering are provided as follows:

| Component No. | Component |
|---|---|
| 2 | Folding Knife |
| 4 | Blade |
| 5 | Cutting Edge |
| 6 | Handle |
| 8 | First Scale |
| 10 | Pivot |
| 12 | Pin |
| 14 | Fastener |
| 16 | Second Scale |
| 17 | Recess |
| 18 | Clip |
| 19a | Aft End (First Scale) |
| 19b | Aft End (Second Scale) |
| 20 | Spacers |
| 21 | Thickness (First Scale) |
| 22 | Aperture |
| 24 | Spine |
| 26 | Tip |
| 28 | Tang |
| 30 | Cam Surface |
| 32 | Pivot Aperture |
| 34 | Closed Depression |
| 36 | Closed Protrusion |
| 38 | Intermediate Portion |
| 40 | Open Protrusion |
| 41 | Stop Surface |
| 42 | Open Depression |
| 43 | Body Portion |
| 44 | First Aperture |
| 46 | Pin Aperture |
| 48 | Fastener Aperture |
| 50 | Bias Member |
| 51a | Base End (Bias Member) |
| 51b | Distal End (Bias Member) |
| 52 | Base Width (Bias Member) |
| 54 | Pivot to Base Length (Bias Member) |
| 56 | Deflection Distance |
| 58 | Pivot Center |
| 60 | Radius |
| 62 | Circle |
| 64 | Circle Center |
| 66 | Offset (Circle Center to Pivot Center) |
| 68a | First End (Intermediate Portion) |
| 68b | Second End (Intermediate Portion) |
| 70 | Stop |
| 72 | Pad |
| 74 | Support |

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

As described in detail below, various embodiments of the present disclosure include novel folding knife designs and configurations, comprising a blade connected to a handle with components that urge and locate the blade into the closed position or the open position like a detent mechanism and/or other features. The present disclosure has significant benefits across a broad spectrum of endeavors. It is the applicant's intent that this specification and the claims appended hereto be accorded a breadth in keeping with the scope and spirit of the invention being disclosed despite what might appear to be limiting language imposed by the requirements of referring to the specific examples disclosed.

Although the following description and attached drawings show the folding tool as a folding knife, the invention can work on any folding tool that rotates from a closed position to an open position. For example, the invention can function on a scraper, nail file, scissors, screwdriver, can opener, saw, etc., or any other folding tool.

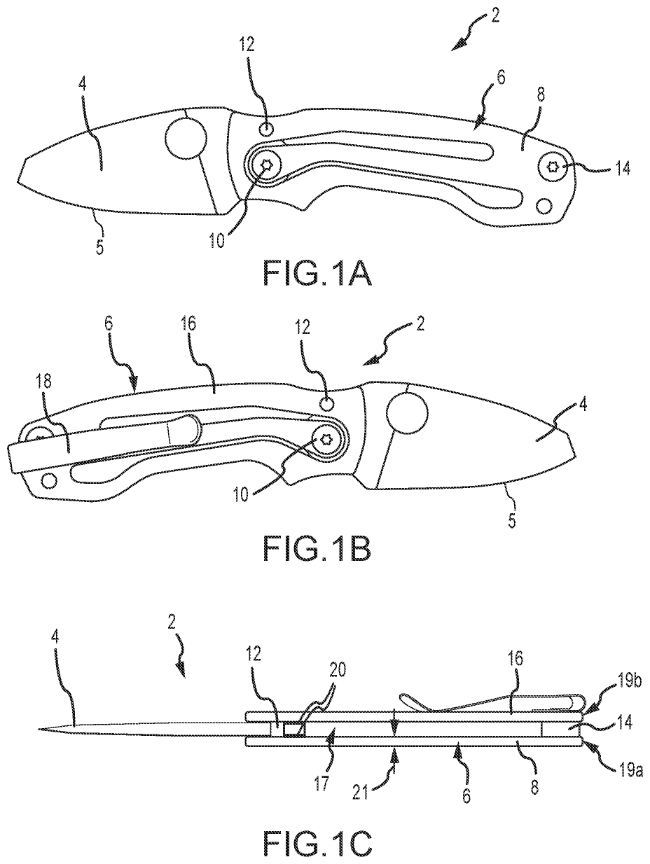

Referring to FIGS. 1A-1C, various views of a folding knife 2 in an open position are provided. Specifically, FIG. 1A is a front elevation view of the folding knife 2, FIG. 1B is a rear elevation view of the folding knife 2, and FIG. 1C is a top plan view of the folding knife 2. Generally, the folding knife 2 comprises a blade 4 that is rotatable relative to a handle 6. In the open position, a cutting edge 5 of the blade 4 is exposed so that a user can utilize the blade 4 for cutting, slicing, etc. As described herein, the present disclosure encompasses a variety of devices, including folding tools or any other device that has two components that rotate relative to each other.

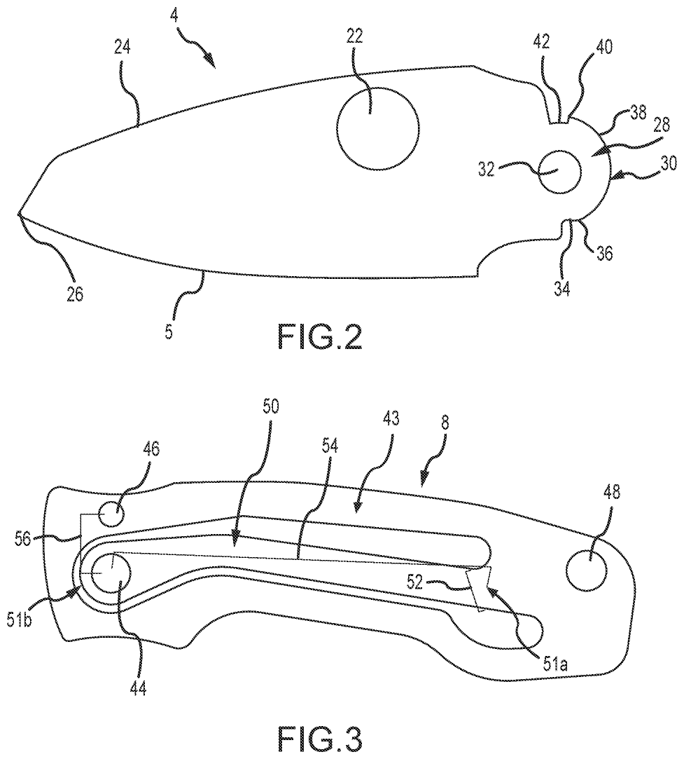

The handle 6 comprises a first scale 8 and a second scale 16 joined together with a pivot 10, a pin 12, and a fastener 14. The pivot 10 extends through a first aperture (44 in FIG. 3) in the first scale 8, a pivot aperture (32 in FIG. 2) in the blade 4, and a second aperture in the second scale 16 to join the blade 4 to the handle 6. In a closed position, the blade 4 is positioned in a recess 17 between the scales 8, 16 so that the cutting edge 5 of the blade 4 is not exposed and is safely stowed. As described herein, part of each scale 8, 16 serves as a bias member to allow the pivot 10 to move relative to the pin 12 to help move or retain the blade 4 in various positions relative to the handle 6. FIG. 1B shows a clip 18 secured to the second scale 16, and the clip 18 can engage a belt, part of a garment, etc. to secure the folding knife 2 to a person or object. The clip 18 is optional and can alternatively be positioned on the first scale 8.

FIG. 1C shows spacers 20 between the blade 4 and the interior surfaces of the first and second scales 8, 16. The inclusion of spacers 20 about the pivot and between the blade 4 and the scales 8, 16 may serve several functions, including preventing over-rotation of the blade 4 relative to the handle 6, altering the movement force to rotate the blade 4 relative to the handle 6, etc. A backspacer (not shown) can also be positioned between the two scales 8, 16 in some embodiments. FIG. 1C also shows that the pin 12 and the fastener 14 span between the scales 8, 16 to define the recess 17. Specifically, the fastener 14 joins an aft end 19a of the first scale 8 to an aft end 19b of the second scale 16. It will be appreciated that more fasteners 14 can also span between the scales 8, 16 or even no fasteners 14 may span between the scales 8, 16. The thickness 21 of the first scale 8 is also shown, and this thickness 21 contributes to the bias force generated by the folding knife 2, as described herein. While the scales 8, 16 are depicted as having the same thickness, it will be appreciated that the present disclosure encompasses embodiments with any combination of thicknesses.

Referring to FIG. 2, a front elevation view of a blade 4 is provided. The blade 4 has an aperture 22 proximate to a spine 24, which is typically a non-cutting edge that may be the only exposed portion of the blade 4 when the blade 4 is in the closed position. Next, the blade 4 has a tip 26 at a distal end of the blade 4, and the tip 26 also defines the end of the spine 24 and the end of the cutting edge 5 of the blade 4 in this embodiment. The present disclosure encompasses various embodiments of the cutting edge 5 of the blade 4. For example, the cutting edge 5 may be a simple, sharped edge. In another example, the cutting edge 5 is partially or wholly comprised of serrations. It will be appreciated that the cutting edge 5 can include any type of edge or feature associated with tools or cutting instruments. The spine 24 can also have a different shape than is shown in FIG. 2 without departing from the invention.

A tang 28 of the blade 4 is positioned opposite the tip 26, and the tang 28 is operably engaged with the handle of the folding knife to rotate between an open position and a closed position. Specifically, the tang 28 comprises a pivot aperture 32, through which a pivot (10 in FIGS. 1A and 1B) extends to join the blade 4 to the scales (8, 16 in FIGS. 1A-1C) of the handle. The tang 28 has a cam surface 30 that engages a pin (12 in FIGS. 1A-1C) to move the pivot, deform the bias member(s), and vary a bias force as the blade 4 rotates relative to the handle. In the depicted embodiment, the cam surface 30 comprises a closed depression 34, a closed protrusion 36, an intermediate portion 38, an open protrusion 40, and a closed depression 42.

Referring to FIG. 3, a front elevation view of the first scale 8 of the folding knife is provided. It will be appreciated that the second scale is generally a mirrored copy of the first scale 8, though the present disclosure encompasses embodiments with other configurations, for instance, where the first and second scales are asymmetrically arranged. The first scale 8 comprises a body portion 43 and a bias member 50. These components 43, 50 are a single continuous structure in some embodiments. As such, the space between the body portion 43 and the bias member 50 can be milled away or otherwise removed to create a scale as shown.

The milled away portion can have a different shape in some embodiments, for example, more or less material can be removed creating a larger or smaller space between the body portion 43 and the bias member 50. In other embodiments, the scale 8 comprises a bias member 50 that is affixed or otherwise engaged with a body portion 43. During operation, the bias member 50 deforms and/or deflects relative to the body portion 43 to vary the bias force generated by the bias member 50.

The first scale 8 has an arrangement of apertures and features that, along with the bias member 50, allow the pivot to move and generate a bias force. Specifically, the bias member 50 has a first aperture 44 through which the pivot extends (also called a pivot aperture 44 herein), and the pivot also extends through a pivot aperture (32 in FIG. 2) in the blade and a second aperture in the second scale to join the blade to the handle. One end 51a or base of the bias member 50 is joined to the body portion 43 of the first scale 8, and the pivot aperture 44 is positioned at an opposing or distal end 51b of the bias member 50. Then, a pin aperture 46 and a fastener aperture 48 extend through the body portion 43 of the first scale 8 to receive a pin and a fastener, respectively. The pin and the fastener extend through respective apertures in the second scale to form the handle. As described herein, the interaction between the cam surface (30 in FIG. 2) and the pin (12 in FIGS. 1A-1C) moves the pivot and changes a deflection distance 56 between the pin and the pivot. The deflection distance 56 is measured from a center of the pivot (which may also be the center of the first aperture or pivot aperture 44) and a center of the pin (which may also be the center of the pin aperture 46). As the pivot moves away from the pin, the bias member 50 is deformed to generate a bias force on the pivot, the cam surface, and the pin.

The bias member 50 is joined to the body portion 43 at only the base end 51a of the bias member 50 in the depicted embodiment. As the pivot deflects, deformation in the bias member 50 is generally absorbed along the length of the bias member 50 to the base end 51a. It will be appreciated that the present disclosure encompasses embodiments where the bias member 50 is joined to the body portion 43 at more than one location. Next, the body portion 43 completely circumscribes the bias member 50 in the depicted embodiment. This arrangement of the bias member 50 and the body portion 43 keeps the thickness (21 in FIG. 1C) of the first scale 8 minimal and promotes the overall portable nature of the folding knife. However, it will be appreciated that the present disclosure encompasses embodiments where the body portion 43 does not completely circumscribe the bias member 50.

Various physical characteristics and features of the first scale 8 and the bias member 50 determine the bias force generated by the bias member 50. The end 51a at which the bias member 50 is joined to the body portion 43 can be described as a base of the bias member 50, and the base has a width 52. The larger the width 52, the larger the bias force for a given deflection distance 56, and the smaller the width 52, the smaller the bias force. Moreover, a length 54 from the base of the bias member 50 to the center of the first aperture 44 also impacts the resulting bias force for a given deflection distance 56. A longer base-to-pivot length 54 generates less bias force as more of the deflection of the pivot is absorbed with elastic deformation of the bias member 50. A shorter length 54 is akin to a shorter, stiffer spring, and will result in a larger bias force for a given deflection distance 56. It is an object of the present disclosure to provide a bias member 50 that remains within the elastic range of deformation below an elastic limit as the deflection distance 56 varies, even when the deflection distance 56 is at a maximum.

The thickness (21 in FIG. 1C) of the first scale 8 also determines how much bias force is generated by the bias member 50 for a given deflection distance 56. A thicker first scale 8 will cause a larger bias force, and a thinner first scale 8 will cause a smaller bias force. Other considerations for the resulting bias force can include the material of the first scale 8, as different materials have different deformation properties. It will be appreciated that while a bias member 50 and force are described with respect to a deformation of a physical component, bias members 50 may include springs, pneumatic systems, etc. that have linear or non-linear responses.

With two mirrored scales, one scale will provide half of the total bias force experienced by the pivot, the cam surface, and the pin. Though in some embodiments, where the scales are asymmetric or there is only a single scale, the bias member may contribute a different proportion or even all of the bias force experienced by these components. Moreover, the pivot, the cam surface, and the pin can be arranged such that bias member always generates at least some bias force even when the deflection distance is at a minimum during operation of the folding knife. Thus, any looseness or play between components of the folding knife is eliminated. However, it will be appreciated that the present disclosure encompasses embodiments where the bias members exert no bias force on the components of the folding knife at some rotational positions of the blade.

In an alternative embodiment of the first scale 8 (and the second scale), the functions of the bias member 50 and the body portion 43 are reversed. Here, the width and/or length of the inner part (bias member 50 in FIG. 3) is changed such that when the pivot and the pin are driven apart and the deflection distance 56 increases, the outer part (body portion 43 in FIG. 3) deforms to accommodate the increased deflection distance 56 and the inner part remains substantially undeformed. Thus, the alternative embodiment of the first scale 8 can be described as a bias member partially or completely circumscribing a body portion where a pin joins bias members of two scales and a pivot joins body portions of two scales.

The first scale 8, and likewise the second scale, can be made from a variety of materials. Preferably, the scales are made from a reliably deformable material like metal, but the scales can be any known material, for example, hard plastic, composite, carbon fiber, fiberglass, wood, ceramic, etc., or combinations thereof.

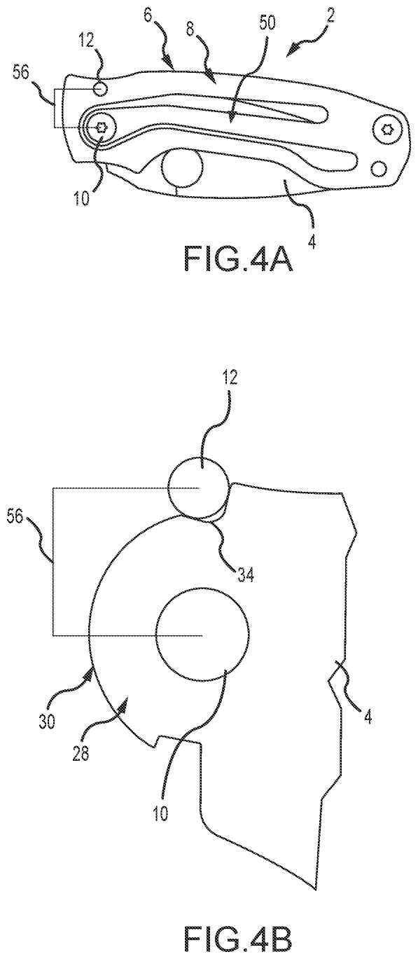

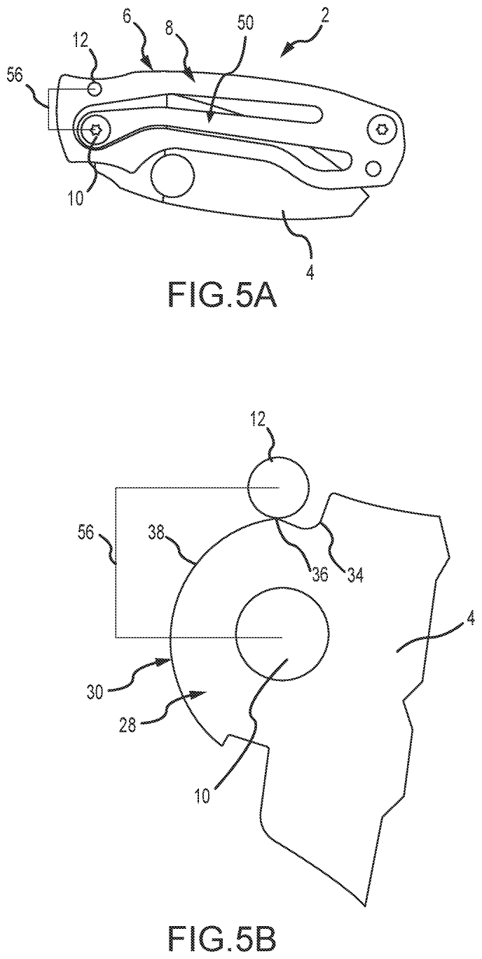

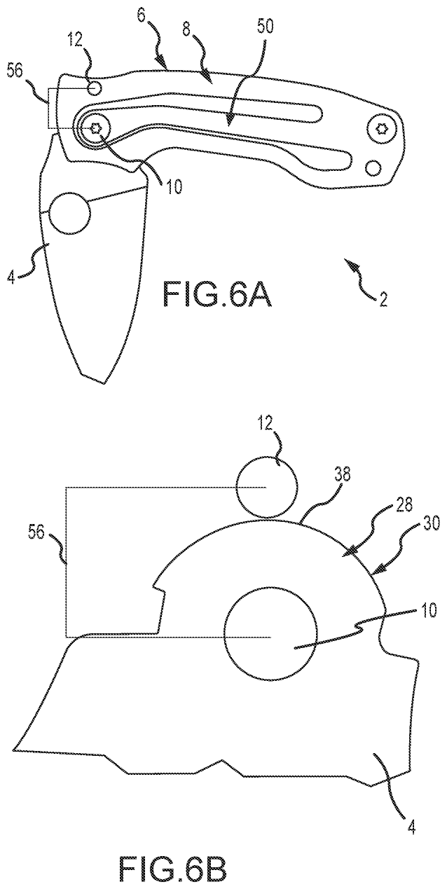

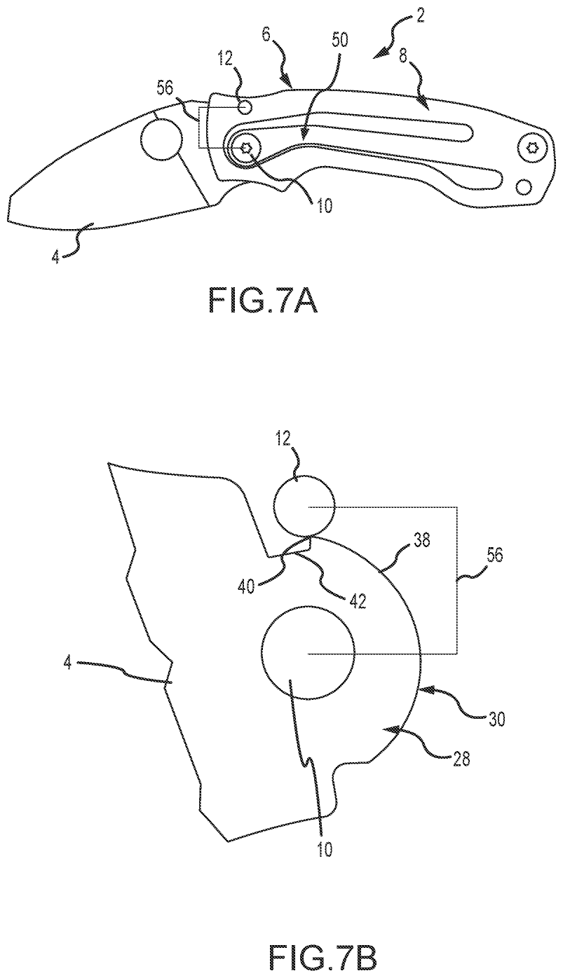

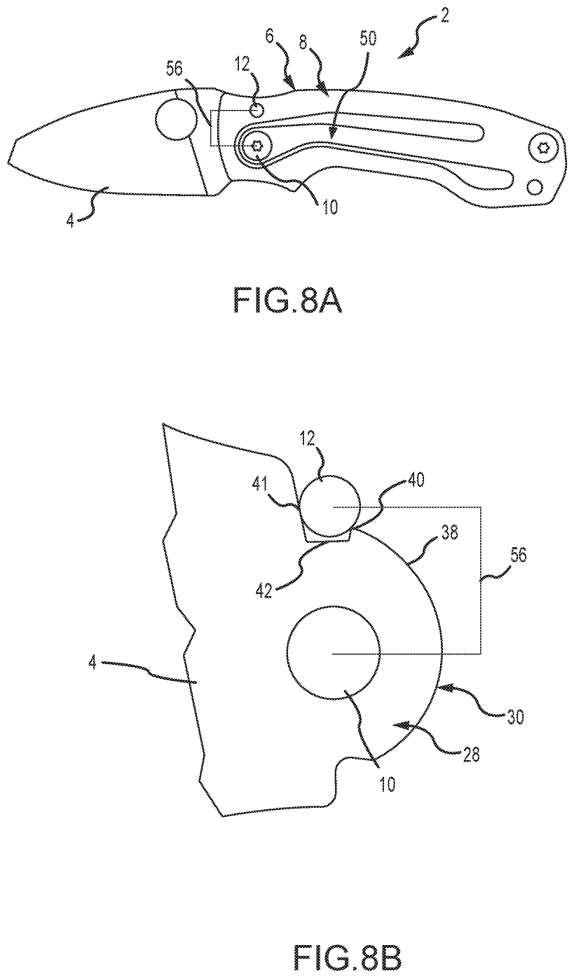

Referring to FIGS. 4A-8B, these figures show the operation of the folding knife 2 and the components at different rotational positions of the blade 4 relative to the handle 6. Specifically, FIGS. 4A-4B show the blade 4 in a closed position, FIGS. 5A-5B show the blade 4 slightly rotated from the closed position, FIGS. 6B-6B show the blade 4 rotated between the closed and open positions at an intermediate position, FIGS. 7A-7B show the blade 4 rotated to a position just before the open position, and FIGS. 8A-8B show the blade 4 in the open position. As the blade 4 changes rotational positions relative to the handle 6, different portions of the cam surface 30 on the tang 28 of the blade 4 contact the pin 12 to move the pivot 10. Accordingly, the deflection distance 56 between the pivot 10 and the pin 12 varies with different rotational positions of the blade 4. The change in deflection distance 56 changes the deformation of the bias members 50 of the handle 6, which changes the bias force that the bias members (only the first scale 8 and the first bias member 50 are visible in FIGS. 4A-8B) apply to the pivot 10, the cam surface 30, and the pin 12. A movement force that is required for a user to rotate the blade 4 may be a function of the bias force and/or a rotational position of the blade 4. As a result, the blade 4 is located and urged into the closed or open positions to reduce the likelihood of an unintentional opening of the blade 4 and exposure of the cutting edge of the blade 4.

Referring to FIGS. 4A-4B, the blade 4 is in the closed position relative to the handle 6. A closed depression 34 of the cam surface 30 on the tang 28 of the blade 4 contacts the pin 12. The deflection distance 56 between the pin 12 and the pivot 10 is at a local minimum, and the bias members 50 of the scales 8 of the handle 6 exert a small amount of bias force. As described herein, the arrangement of the cam surface 30, the pin 12, and the pivot 10 shown in FIGS. 4A-4B operates in concert with the arrangement shown in FIGS. 5A-5B to urge the blade 4 in the closed position relative to the handle 6 like a detent mechanism.

Referring to FIGS. 5A-5B, the blade 4 is slightly rotated open from the closed position relative to the handle 6. Here, the user has turned a closed protrusion 36 of the cam surface 30 of the tang 28 into the pin 12. This pushes the tang 28 and the pivot 10 away from the pin 12, which deforms the bias members 50 of the scales 8. FIG. 5A shows the deflection of the pivot 10 away from the pin 12 and an increase in the deflection distance 56 compared to the deflection distance 56 in FIGS. 4A-4B. With the larger deflection distance 56, the bias members 50 experience more elastic deformation, and thus, exert a larger bias force on the pivot 10, the cam surface 30, and the pin 12.

In FIGS. 5A-5B, the pin 12 is positioned at local maximum or inflection point of the cam surface 30, specifically at an apex of the closed protrusion 36. The closed protrusion 36 is at the end or edge of the closed depression 34 of the cam surface 30, meaning that the closed protrusion 36 is positioned between the closed depression 34 and the intermediate portion 38 of the cam surface 30. Therefore, the large bias force caused by the bias members 50 in combination with a small movement force in the closing direction urges the blade 4 back toward the closed position. To move the blade 4 entirely out of the closed position relative to the handle 6, a user must exert enough movement force on the blade 4 to rotate the closed protrusion 36 past the pin 12 to continue the opening movement of the blade 4. Otherwise, the blade 4 reverts back to the closed position. In this sense, the components of the folding knife 2 locate and urge the blade 4 into the closed position like a detent mechanism. This operation between the pin 12 and the cam surface 30 reduces the likelihood of an unintentional opening of the blade 4.

Referring to FIGS. 6A-6B, the blade 4 is between the closed and open positions relative to the handle 6. In this intermediate position, the deflection distance 56 is slightly less than the deflection distance 56 shown in FIGS. 5A-5B but the deflection distance 56 is more than the deflection distance 56 shown in FIGS. 4A-4B. In this embodiment, as the user rotates the blade 4 relative to the handle 6, the required movement force is continuously variable. In other embodiments, the deflection distance 56 remains constant as a user rotates the blade 4 and the intermediate portion 38 of the cam surface 30 against the pin 12. In these embodiments, as the user rotates the blade 4 relative to the handle 6, the required movement force is constant and non-varying.

Referring to FIGS. 7A-7B, the blade 4 is rotated to a position just before the open and locked position relative to the handle 6. An open protrusion 40 of the cam surface 30 on the tang 28 of the blade 4 contacts the pin 12. The open protrusion 40 is at the end or edge of the open depression 42 such that the open protrusion 40 is positioned between the open depression 42 and the intermediate portion 38. In this position, the pin 12 and the pivot 10 are driven apart, and the deflection distance 56 is greater than the deflection distance 56 shown in FIGS. 6A-6B. Thus, the bias members 50 of the scales 8 are elastically deformed, which causes a larger bias force to act on the pivot 10, the cam surface 30, and the pin 12. Like the arrangement in FIGS. 5A-5B, the pin 12 is positioned on a local maximum of the cam surface 30, specifically an apex of the open protrusion 40. Thus, the large bias force caused by the bias members 50 in combination with a small movement force in the opening direction urges the blade 4 into the open position. The open protrusion 40 and its effects on the bias force and the movement force can provide useful feedback to a user who is attempting to fully open the blade 4 relative to the handle 6. Once the user feels the varying movement forces as the blade 4 rotates and the open protrusion 40 clears the pin 12, then the blade 4 is urged into the open position and the user understands that the opening operation is complete.

Referring to FIGS. 8A-8B, the blade 4 is in the open position relative to the handle 6. Now the open protrusion 40 of the cam surface 30 has cleared the pin 12, and the open depression 42 of the cam surface 30 contacts the pin 12. In some embodiments, the pin 12 is positioned in the open depression 42 and against a stop surface 41. The deflection distance 56 is now less than the deflection distance 56 shown in FIGS. 7A-7B. Thus, the bias force exerted by the bias members 50 is less. Like the operation of the closed depression 34 and the closed protrusion 36, the open depression 42 and the open protrusion 40 are arranged such that a user starting to close the blade 4 from the open position needs to exert a sufficiently large movement force to rotate the blade 4 and the cam surface 30, specifically, such that open protrusion 40 moves past the pin 12. This arrangement of components operates like a detent mechanism and reduces the likelihood that the blade 4 will unintentionally move out of the open position.

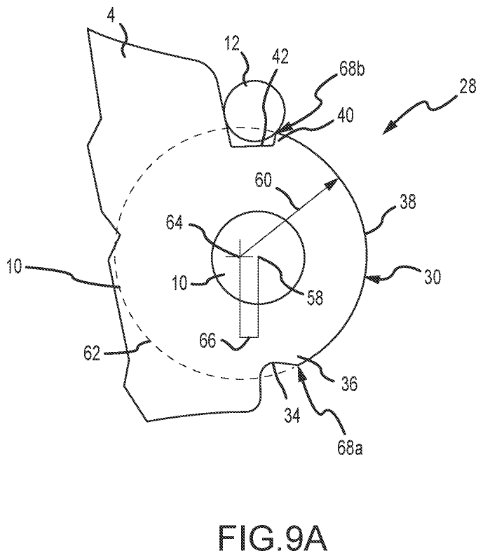

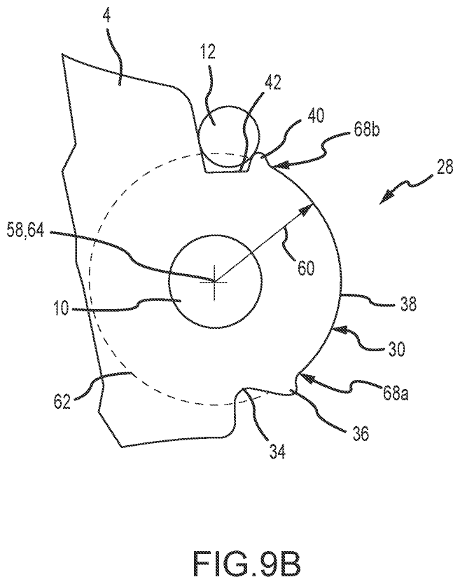

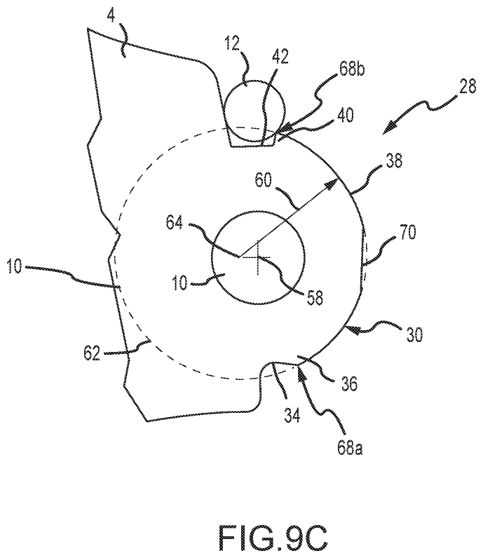

Referring to FIGS. 9A-9C, front elevation views of a pin 12 and a cam surface 30 on a tang 28 are provided. These figures show how different cam surfaces 30 can provide the desired effects described herein, including moving the pivot, varying the bias force, and varying the required movement force. In FIG. 9A, the cam surface 30 has a closed depression 34, a closed protrusion 36, an intermediate portion 38, an open protrusion 40, and an open depression 42. A radius 60 defines a circle 62 with a center 64, and the intermediate portion 38 extends along part of the circle 62 defined by the radius 60. The cam surface 30 departs from this circle 62 at the closed depression 34 and at the open depression 42, which each extend into the circle 62.

In this embodiment, the closed protrusion 36 is one end 68a of the intermediate portion 38, and the open protrusion 40 is an opposing end 68b of the intermediate portion 38. These protrusions 36, 40 are local maximums of the cam surface 30 engaged with the pin 12, and these local maximums are created by an offset 66 between the center 64 of the circle 62 and a center 58 or rotation axis of the pivot 10. If no offset 66 existed, the protrusions 36, 40 would not be local maximums because the tips or apexes of the protrusions 36, 40 are positioned on the circle 62. Beginning at the first end 68a of the intermediate portion 38, as the intermediate portion 38 of the cam surface 30 rotates against the pin 12 in the opening direction, the center 58 of the pivot 10 moves closer to the pin 12 until the midpoint of the intermediate portion 38 reaches the pin 12. Then, continuing in the opening direction, the center 58 of the pivot 10 moves away from the pin 12 until the second end 68b of the intermediate portion 38 reaches the pin 12. In this sense, the movement force needed for a user to move the intermediate portion 38 of the cam surface 30 against the pin 12 can be described as a continuously variable movement force.

FIG. 9B shows another embodiment of the cam surface 30 of the tang 28. In this embodiment, the intermediate portion 38 of the cam surface 30 extends along part of a circle 62 defined by a radius 60 where the pivot center 58 and the circle center 64 are aligned. Thus, as a user applies a movement force to the blade 4 to rotate the intermediate portion 38 against the pin 12, the movement force is constant and non-varying. Moreover, in this embodiment, the closed protrusion 36 and the open protrusion 40 are separate from the intermediate portion 38, and each protrusion 36, 40 extends beyond the circle 62 defined by the radius 60. In other words, the tips or apexes of the protrusions 36, 40 are positioned farther away from the circle center 64 than the circle 62, which is required to create local maximums. Here, the closed protrusion 36 is positioned between the closed depression 34 and the intermediate portion 38. Like the embodiment in FIG. 9A, the closed depression 34 and the closed protrusion 36, along with other components, operate like a detent mechanism. In this embodiment, the closed protrusion 36 can also operate like a spring-assisted opening mechanism. When the apex of the closed protrusion 36 is positioned against the pin 12, the bias force generated by the deformed bias members is larger. This bias force in combination with a small movement force in the opening direction will urge the blade 4 in the opening direction to assist a user in opening the blade 4 relative to the handle of the folding knife.

The open protrusion 40 is similarly arranged as the closed protrusion 36. The open protrusion 40 is positioned between the intermediate portion 38 of the cam surface 30 and the open depression 42. When the apex of the open protrusion 40 is positioned against the pin 12, the bias force generated by the deformed bias members is larger. This bias force in combination with a small movement force in the closing direction will urge the blade 4 in the closing direction to assist a user in closing the blade 4 relative to the handle of the folding knife. It will be appreciated that the embodiments of the cam surface 30 in FIGS. 9A and 9B are exemplary in nature, and the present disclosure encompasses a variety of cam surfaces 30 and protrusions 36, 40. For instance, the cam surface 30 may optionally include any surface shape or portion, offset, etc.

FIG. 9C shows a further embodiment of a cam surface 30 on a tang 28 of the blade 4. Here, a portion of the intermediate portion 38 of the cam surface 30 is on a circle 62 defined by a radius 60 where the pivot center 58 is offset from the circle center 64. However, in other embodiments, the pivot center 58 and the circle center 64 are aligned. Specifically, the intermediate portion 38 of the cam surface 30 comprises a stop 70, which in this embodiment is a depression or cutout that extends inward of the circle 62 defined by the radius 60. The stop 70 inhibits or at least signals to the user to slow the opening motion or the closing motion of the blade 4 relative to the handle to prevent the blade 4 from opening or closing too quickly, which could be a potential safety issue. As the blade 4 rotates, the stop 70 contacts the pin 12, which interrupts the normally continuous motion of the intermediate portion 38 against the pin 12. The sudden change in movement force and/or bias force can be a signal to the user to cautiously open or close the blade 4. In other embodiments, the stop 70 is a protrusion that extends outward beyond the circle 62 defined by the radius 60. Thus, not only does the user experience the change in movement force and/or bias force, but the user needs to exert a larger movement force to drive the stop 70 past the pin 12, akin to a speed bump on a road, to inhibit the blade 4 from opening or closing too quickly. It will be appreciated that the stop 70 can have any shape that deviates from the circle 62 such as the open or closed depressions, the open or closed protrusions, as well as the flat shape shown in FIG. 9C. Moreover, the stop 70 can be described as a separate portion of the cam surface 30 that divides a first intermediate portion 38 and a second intermediate portion 38 of the cam surface 30, in some embodiments.

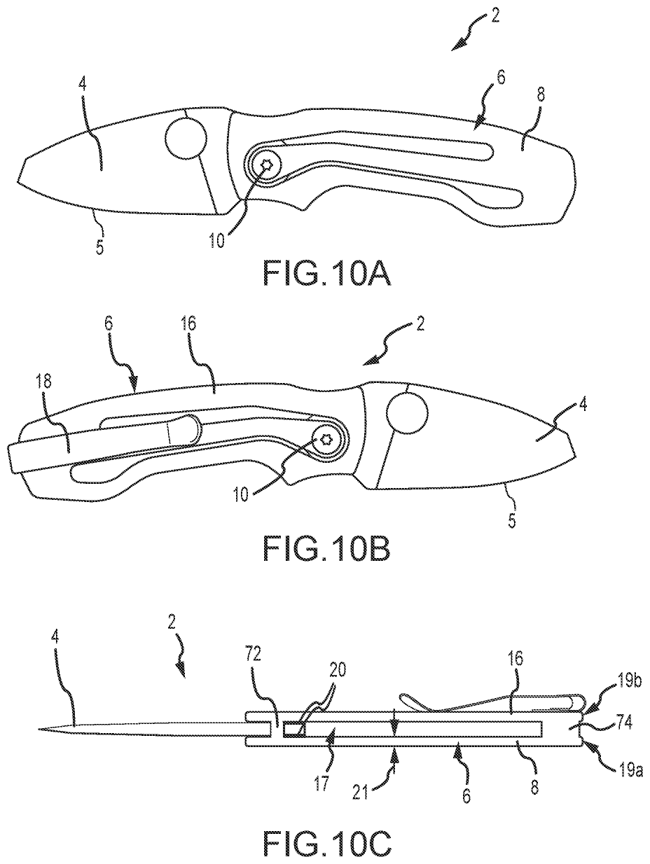

Referring to FIGS. 10A-10C, various views of a folding knife 2 with a handle 6 generally made from a single billet are provided. Specifically, FIG. 10A is a front elevation view of the folding knife 2, FIG. 10B is a rear elevation view of the folding knife 2, and FIG. 10C is a top plan view of the folding knife 2. The handle 6 in this embodiment is generally made from a single billet, or continuous piece of material. Therefore, the scales 8, 16 in FIGS. 10A-10C do not comprise an aperture for a pin or an aperture for fasteners. Rather, a billet is formed into the handle 6 shown, and a continuous pad 72 spans the scales 8, 16 instead of a pin (12 in FIGS. 1A-1C) and a continuous support 74 spans the scales 8, 16 instead of a fastener (14 in FIGS. 1A and 1C). The pad 72 can be shaped like a pin and serve the same functions as the pin. Likewise, the support 74 can be shaped like a fastener and serve the same functions as the fastener. In alternative embodiments, the pad 72 and the support 74 are part of the same continuous liner that spans the scales 8, 16 and also serves the functions of the pin and the fastener while providing additional support and rigidity to the body portions of the scales 8, 16.

The handle 6 shown in FIGS. 10A-10C can be stronger and can be easier to manufacture compared to the handle 6 in FIGS. 1A-1C. In some embodiments, the single billet is milled from the bottom and/or top to form the recess 17 between the scales 8, 16 as well as any feature that spans the scales 8, 16 like the pad 72 or the support 74. Then, the single billet is milled from one or both of the sides to remove material from one or both scales 8, 16 and form the bias member, the body portion, and any necessary apertures of one or both scales 8, 16. It will be appreciated that the folding knife 2 can optionally incorporate any of the features and components described herein.

In further embodiments, the handle 6 is generally manufactured from a single billet to have only a single scale with a bias member. In these embodiments, the single scale may be the first scale 8 or the second scale 16. In one example, the pad 72 is integrated with the first scale 8 such that the pad 72 and the first scale 8 are a single continuous structure. Thus, the pivot 10 joins the blade 4 to an aperture in the bias member of the first scale 8, and the folding knife 2 operates as described herein. In these embodiments, the handle 6 may completely lack an opposing, second scale 16, or the second scale 16 may be a blank without a bias member such that the first scale 8 provides all of the bias force during operation of the folding knife 2. Further still, a second scale 16 may be continuous with or separately affixed to the first scale 8 and pad 72. This allows for the second scale 16 to be made from a different material in some embodiments, for instance, a transparent or translucent material that allows a user to view the blade 4 through the second scale 16. Moreover, it will be appreciated that any manufacturing process described herein is exemplary in nature. For instance, the generally single and continuous structure of the handle 6 shown in FIGS. 10A-10C can be made by additive manufacturing.

The foregoing description of the present invention has been presented for illustration and description purposes. However, the description is not intended to limit the invention to only the forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Consequently, variations and modifications commensurate with the above teachings and skill and knowledge of the relevant art are within the scope of the present invention. The embodiments described herein above are further intended to explain best modes of practicing the invention and to enable others skilled in the art to utilize the invention in such a manner, or include other embodiments with various modifications as required by the particular application(s) or use(s) of the present invention. Thus, it is intended that the claims be construed to include alternative embodiments to the extent permitted by the prior art.

Any one or more aspects described herein can be combined with any other one or more aspects described herein. Any one or more features described herein can be combined with any other one or more features described herein. Any one or more embodiments described herein can be combined with any other one or more embodiments described herein. It is to be appreciated that any feature described herein can be claimed in combination with any other feature(s) as described herein, regardless of whether the features come from the same described embodiment.

What is claimed is:

1. A folding knife, comprising:
a handle having a first scale and a second scale joined at a pivot and at a pin;
a blade having a tip and a tang opposite the tip, a portion of the blade positioned between the first and second scales, wherein the pivot extends through a pivot aperture in the tang of the blade, and the blade is configured to rotate about the pivot and relative to the handle between a closed position and an open position; and
the tang of the blade having a cam surface with a depression and a protrusion, wherein the depression is configured to contact the pin so that the pivot is a first distance from the pin, and the protrusion is configured to contact the pin so that the pivot is a second distance from the pin, and wherein the second distance is greater than the first distance.

2. The folding knife of claim 1, wherein the depression is configured to contact the pin to locate the blade in one of the closed position or the open position.

3. The folding knife of claim 1, wherein the protrusion is configured to contact the pin as the blade is between the closed position and the open position.

4. The folding knife of claim 1, further comprising:
a first bias member of the first scale; and
a second bias member of the second scale, wherein the pivot extends through a first aperture in the first bias member and through a second aperture in the second bias member, and the first and second bias members are configured to selectively deform as the pivot moves relative to the pin, and deformation of the first and second bias members generates a bias force on the pivot, the cam surface, and the pin.

5. The folding knife of claim 4, wherein one end of the first bias member is connected to a first body portion of the first scale, and the first aperture is positioned at an opposing end of the first bias member, and wherein one end of the second bias member is connected to a second body portion of the second scale, and the second aperture is positioned at an opposing end of the second bias member.

6. The folding knife of claim 4, wherein the blade is configured to receive a movement force to rotate the cam surface against the pin, and the movement force is a function of at least the bias force and a position of the cam surface relative to the pin.

7. A folding knife, comprising:
a handle having a first scale with a first body portion and a first bias member, and the handle having a second scale with a second body portion and a second bias member, wherein the first and second scales are joined with a pivot and with a pin;
a blade positioned between the first and second scales, wherein the pivot extends through a pivot aperture in the blade, and the blade is configured to rotate about the pivot and relative to the handle;
wherein, in a first rotation position of the blade relative to the handle, the first and second bias members are configured to deform relative to the respective first and second body portions such that the first and second bias members apply a first bias force on the pivot and the pin; and
wherein, in a second rotation position of the blade relative to the handle, the first and second bias members are configured to deform relative to the respective first and second body portions such the first and second bias members apply a second bias force on the pivot and the pin that is greater than the first bias force.

8. The folding knife of claim 7, wherein, in the first rotation position of the blade relative to the handle, the pivot is a first distance from the pin; and
wherein, in the second rotation position of the blade relative to the handle, the pivot is a second distance from the pin that is greater than the first distance.

9. The folding knife of claim 8, wherein the second distance is a maximum distance between the pivot and the pin, and deformation of the first and second bias members at the second distance is configured to remain in an elastic range below an elastic limit.

10. The folding knife of claim 7, wherein the first body portion and the first bias member of the first scale are a single continuous structure, and the second body portion and the second bias member of the second scale are a single continuous structure.

11. The folding knife of claim 7, wherein the first bias member is connected to the first body portion at only a base of the first bias member, the pivot extends through a first aperture in the first bias member, and a length between a center of the first aperture and the base is greater than a width of the base.

12. The folding knife of claim 7, wherein the first body portion circumscribes the first bias member, and the second body portion circumscribes the second bias member, and wherein the first and second bias members are joined with the pivot, and the first and second body portions are joined with the pin.

13. The folding knife of claim 7, wherein the first bias member circumscribes the first body portion, and the second bias member circumscribes the second body portion, and wherein the first and second bias members are joined with the pin, and the first and second body portions are joined with the pivot.

14. A folding knife, comprising:
a handle having a first scale and a pad, wherein the first scale and the pad are a single continuous structure;
a blade having a tip and a tang opposite the tip, a portion of the blade positioned adjacent to the first scale, wherein a pivot extends through a pivot aperture in the tang of the blade and into the first scale, and the blade is configured to rotate about the pivot and relative to the handle between a closed position and an open position;
the tang of the blade having a cam surface with an intermediate portion defined by a constant radius, wherein the cam surface has a closed protrusion at one end of the intermediate portion and an open protrusion at an opposing end of the intermediate portion;
wherein the blade is configured to receive a first movement force to move the closed protrusion past the pad, deflect the pivot relative to the pad, and locate the blade in the closed position; and
wherein the blade is configured to receive a second movement force to move the open protrusion past the pad, deflect the pivot relative to the pad, and locate the blade in the open position.

15. The folding knife of claim 14, wherein the cam surface comprises a closed depression adjacent to one end of the intermediate portion and an open depression adjacent to the opposing end of the intermediate portion, and wherein the closed depression is configured to contact the pad to locate the blade in the closed position, and the open depression is configured to contact the pad to locate the blade in the open position.

16. The folding knife of claim 15, wherein a rotation axis of the pivot is offset from a center of a circle defined by the constant radius, and wherein the closed protrusion is directly adjacent to the closed depression, and the open protrusion is directly adjacent to the open depression.

17. The folding knife of claim 14, wherein the closed protrusion and the open protrusion each extend outward beyond a circle defined by the constant radius, wherein the closed protrusion is positioned between a closed depression and the intermediate portion, and the open protrusion is positioned between an open depression and the intermediate portion, wherein the closed depression is configured to contact the pad to locate the blade in the closed position, and the open depression is configured to contact the pad to locate the blade in the open position, and wherein a rotation axis of the pivot is aligned with a center of the circle defined by the constant radius.

18. The folding knife of claim 14, wherein the handle comprises only the first scale and the pad.

19. The folding knife of claim 18, further comprising:
a second scale, wherein the first scale and the second scale are joined at the pivot and at the pad, wherein the first scale, the second scale, and the pad are a single continuous structure, and the blade is positioned between the first and second scales;
a first bias member of the first scale; and
a second bias member of the second scale, wherein the pivot extends through a first aperture in the first bias member and through a second aperture in the second bias member, and the first and second bias members are configured to deform and generate a bias force on the pivot, the cam surface, and the pad as the cam surface rotates against the pad.

20. The folding knife of claim 19, wherein the bias force is configured to urge the blade into the closed position as the closed protrusion moves past the pad, and the bias force is configured to urge the blade into the open position as the open protrusion moves past the pad.
